(19) United States
(12) Patent Application Publication
(10) Pub. No.: US 2008/0122807 A1
(43) Pub. Date: May 29, 2008

(54) INPUT DEVICE

(75) Inventors: Li-Sen Chen, Taoyuan Hsien (TW); Chien-Yu Hsu, Taoyuan Hsien (TW); Hui-Hsueh Chiang, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: SPEED TECH CORP., Taoyuan Hsien (TW)

(21) Appl. No.: 11/563,207

(22) Filed: Nov. 26, 2006

(51) Int. Cl. G06F 3/033

(52) U.S. Cl. 345/184

(57) ABSTRACT

An input device disposed on a circuit board is provided. The input device includes a frame, a sliding base, a rotary wheel, and a switch. The sliding base is slidingly connected to the frame. The sliding base substantially slides linearly along a slide axis. The slide axis is substantially parallel to the circuit board. The rotary wheel is revolvably affixed to the sliding base. The rotary wheel is substantially rotates around a rotation axis. The rotation axis is substantially perpendicular to the circuit board. The switch is disposed on the frame. The rotary wheel actuates the switch through the sliding motion of the sliding base. Accordingly, some merits of said input device include smaller volume, easy assembling and better durability.

### BACKGROUND OF THE INVENTION

1. Field of the Invention

The present invention relates to an input device, and more particularly to an input device having a sliding type of rotary wheel.

2. Description of Related Art

The user of a mobile phone or a computer screen often makes use of the rotation mechanism of an input device to control a cursor and perform a scrolling, point and click or picture zooming action. The most common input devices include mouse, trackball, joystick and game pad, for example. A user can effectively perform operation through some of these input devices.

FIG. 1A is a schematic perspective view of a conventional input device. FIG. 1B is a schematic perspective view showing some of the components inside the input device in FIG. 1A. As shown in FIGS. 1A and 1B, the conventional input device 100 is disclosed in U.S. Pat. No. 7,075,526. The conventional input device 100 is a mouse comprising a housing 110, a supporting skeleton 120, a roller 130, a switch 140 and a spring 150. A portion of the roller 130 is exposed outside the housing 110. Furthermore, the roller 130 is disposed on the supporting skeleton 120 and the spring 150 connects between the roller 130 and the switch 140.

Aside from rotating the roller 130 to transmit electrical signals, the user may press on the roller 130 and drive the spring 150 to make electrical contact and actuate the switch 140. However, the conventional input device 100 occupies a rather large volume.

FIG. 2 is a schematic cross-sectional view of another conventional input device. The conventional input device 200 is disclosed in U.S. Pat. No. 6,229,103. The input device 200 includes a base board 210, a movable member 220, a rotary wheel 230, a switch 240 and an L-shaped actuator 250. The movable member 220 is movably affixed to the base board 210. In other words, the movable member 220 is assembled on the base board 210. Furthermore, the movable member 220 can have a certain degree of movement relative to the base board 210. The rotary wheel 230 is revolvably affixed to the movable member 220 and disposed in a middle part of the base board 210. The switch 240 is disposed in the rear part (the right side of FIG. 1) of the base board 210. Moreover, the L-shape actuator 250 is disposed between the movable member 220 and the switch 240.

Aside form rotating the rotary wheel 230 to transmit electrical signals, the user may move the rotary wheel 230 and drag the movable member 220 and the L-shaped actuator 250 to actuate the switch 240. With the current trend of miniaturizing the input device 200, the size of the L-shaped actuator 250 must also be shrunk. However, shrinking the size of the L-shaped actuator 250 may increase the difficulty of assembling the L-shaped actuator 250 to the space between the movable member 220 and the switch 240 in the production line. In addition, the L-shaped actuator 250 is more vulnerable to damage when the user exerts too much force.

### SUMMARY OF THE INVENTION

Accordingly, the present invention is to provide an input device that occupies a small volume and is easier to assemble and more durable.

The present invention provides an input device disposed on a circuit board. The input device includes a frame, a sliding base, a rotary wheel and a switch. The sliding base is slidingly connected to the frame. The sliding base substantially slides linearly along a slide axis. The slide axis is substantially parallel to the circuit board. The rotary wheel is revolvably affixed to the sliding base. The rotary wheel substantially rotates around a rotation axis. The rotation axis is substantially perpendicular to the circuit board. The switch is disposed on the frame. The rotary wheel actuates the switch through the sliding motion of the sliding base.

In an embodiment of the present invention, the frame has at least a first sliding connection portion and the sliding base has at least a second sliding connection portion so that the sliding base may slide linearly inside the frame through the relative sliding motion between the second sliding connection portion and the first sliding connection portion. In addition, the frame includes a first sidewall and a second sidewall. The first sidewall is substantially parallel to the slide axis and perpendicular to the circuit board. The second sidewall and the second sidewall face each other. The frame further includes a third sidewall connecting with the first sidewall and the second sidewall. Furthermore, the switch is disposed on the second sidewall, the first sidewall or the third sidewall and on the sliding path of the sliding base.

In an embodiment of the present invention, the input device further includes at least a limiting portion disposed on the frame and the sliding base slides within the limited space between the frame and the limiting portion.

In an embodiment of the present invention, the sliding base further includes a press board located between rotary wheel and the switch and the switch is actuated by the press board of the sliding base while the sliding base is in a sliding motion.

Accordingly, because the rotary wheel, the sliding base and the circuit board in the input device of the present invention has a low profile, the input device may satisfy the trend for miniaturization. In addition, because the switch in the input device of the present invention is actuated through the sliding motion of the sliding base, the L-shaped actuator in a conventional input device is not required. Hence, the input device of the present invention may be easily assembled and more durable.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic perspective view of a conventional input device.

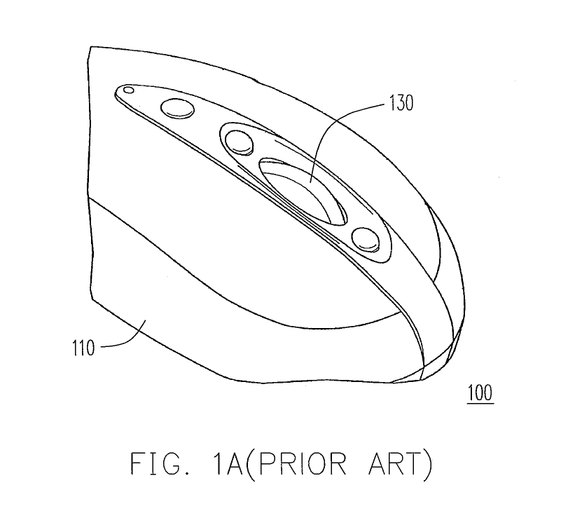

FIG. 1B is a schematic perspective view showing some of the components inside the input device in FIG. 1A.

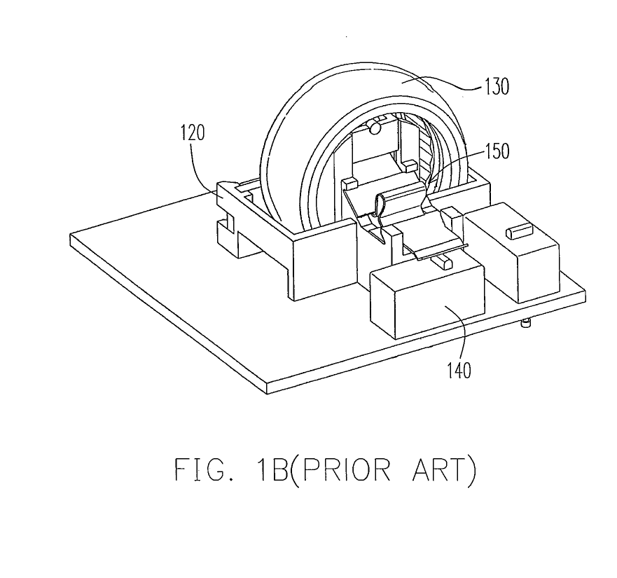

FIG. 2 is a schematic cross-sectional view of another conventional input device.

FIG. 3 is a schematic perspective view of an input device according to a first embodiment of the present invention.

FIG. 4 is a schematic partial explosion view of the input device in FIG. 3.

FIG. 5 is a schematic cross-sectional view along line I-I of the input device in FIG. 3.

FIG. 6 is a schematic top view of the input device in FIG. 3.

FIG. 7 is a schematic perspective view of another input device according to the first embodiment of the present invention.

FIG. 8 is a schematic perspective view of an input device according to a second embodiment of the present invention.

FIG. 9 is a schematic top view of the frame in FIG. 8.

FIG. 10 is a schematic front view of the input device in FIG. 8.

FIG. 11 is a schematic cross-sectional view of an input device according to a third embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

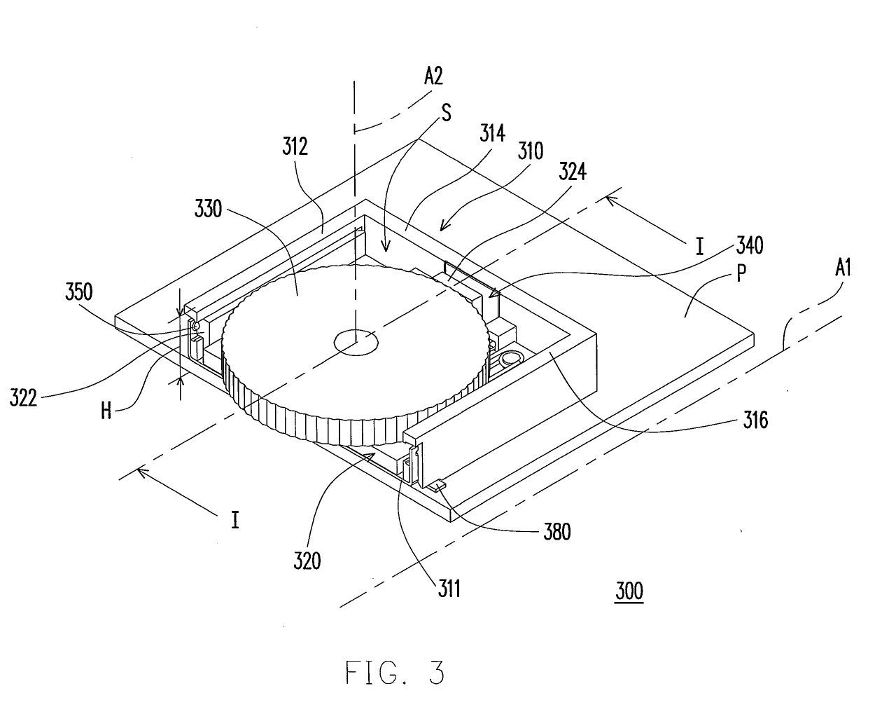

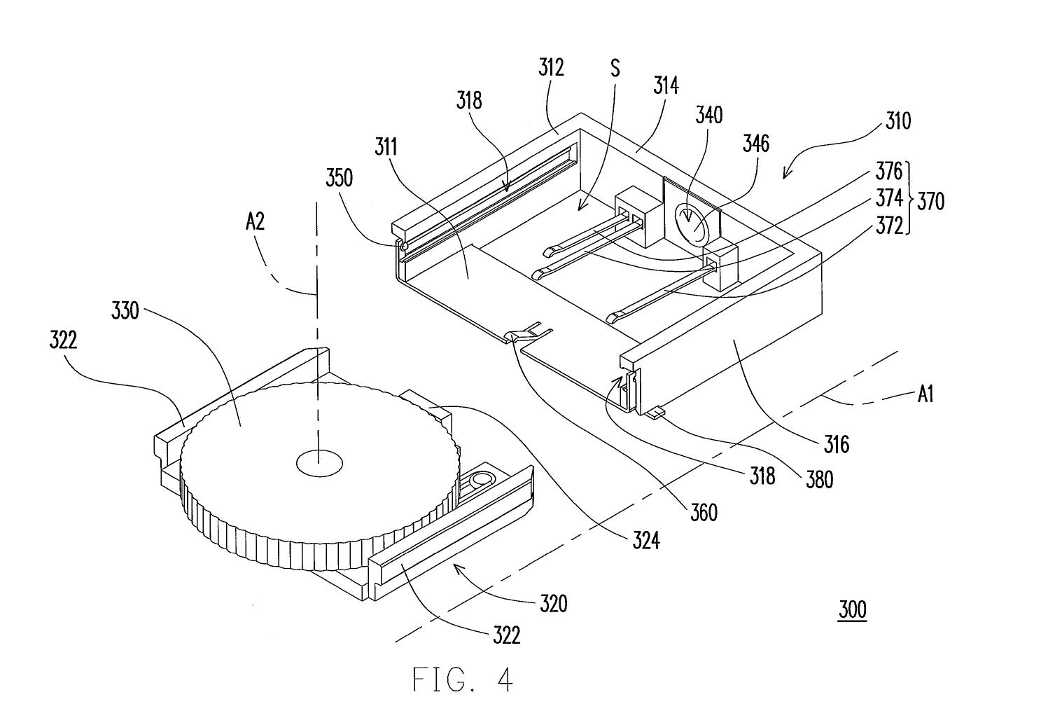

FIG. 3 is a schematic perspective view of an input device according to a first embodiment of the present invention. FIG. 4 is a schematic partial explosion view of the input device in FIG. 3. As shown in FIGS. 3 and 4, the input device 300 in the first embodiment is disposed on a circuit board P. The input device 300 includes a frame 310, a sliding base 320, a rotary wheel 330 and a switch 340. The sliding base 320 is slidingly connected to the frame 310. The sliding base 320 substantially slides linearly along a slide axis A1. The slide axis A1 is substantially parallel to the circuit board P. The rotary wheel 330 is revolvably affixed to the sliding base 320. The rotary wheel 330 substantially rotates around a rotation axis A2. The rotation axis A2 is substantially perpendicular to the circuit board P. In addition, the switch 340 is disposed on the frame 310. The rotary wheel 330 actuates the switch 340 through the sliding motion of the sliding base 320.

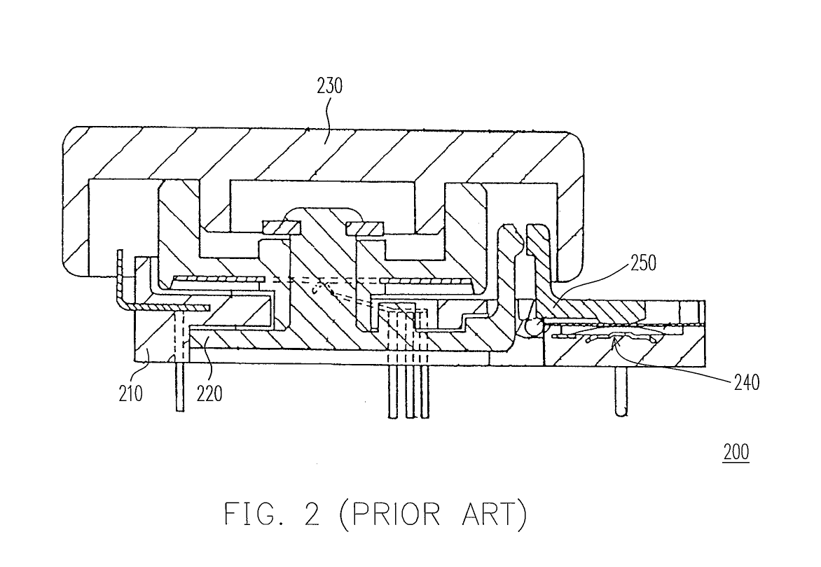

Because the rotary wheel 330 of the input device 300 substantially rotates around the rotation axis A2 perpendicular to the circuit board P and the sliding base 320 substantially slides linearly along the slide axis A1, the overall height H of the rotary wheel 330, the sliding base 320 and the circuit board P is lower. Therefore, compared with the conventional input device 100, the input device 300 in the present embodiment occupies a smaller volume. In addition, because the switch 340 of the input device 300 is actuated through the sliding motion of the sliding base 320, the L-shaped actuator 250 (as shown in FIG. 2) of the conventional input device 200 is not required. Therefore, the input device 300 of the present embodiment may be easily assembled and more durable.

The frame 310 and the rotary wheel 330 in the first embodiment are fabricated by using an insulating material, for example. Furthermore, the frame 310 includes a sidewall 312, a sidewall 314 and a sidewall 316. The sidewall 312 is substantially parallel to the slide axis A1 and hence perpendicular to the circuit board P, and the sidewall 314 is substantially perpendicular to the slide axis A1. The sidewall 316 and the sidewall 312 face each other and the sidewall 314 connects with the sidewall 312 and the sidewall 316 so as to reinforce the mechanical strength of the frame 310. In addition, the switch 340 may be disposed on the sidewall 314. In the first embodiment, when the rotary wheel 330 and the sliding base 320 slides linearly inside the frame 310 along the slide axis A1, the rotary wheel 330 may apply a pressure on the switch 340 and actuate the switch 340.

Furthermore, the frame 310 may have two first sliding connection portions 318 disposed on the sidewalls 312 and 316 respectively. The first sliding connection portions 318 are substantially parallel to the slide axis A1. The sliding base 320 may have two second sliding connection portions 322 disposed on two opposite sides, and the two second sliding connection portions 322 may be slidingly connected to the first sliding connection portions 318 respectively. Therefore, the sliding base 320 and the frame 310 may have relative sliding motion through the second sliding connection portions 322 and the first sliding connection portions 318. In other words, the first sliding connection portions 318 and the second sliding connection portions 322 together form the basis for the relative sliding motion between the sliding base 320 and the frame 310.

In the first embodiment, each first sliding connection portion 318 may be a sliding rail and each second sliding connection portion 322 may be a sliding block. It should be noted that the designer might design each of the first sliding connection portions 318 as a sliding block and each of the second sliding connection portions 322 as a sliding rail according to the actual requirement as long as the sliding and connecting functions of the foregoing sliding base 320 to the frame 310 are unaffected. However, the foregoing conditions are not shown in the drawings.

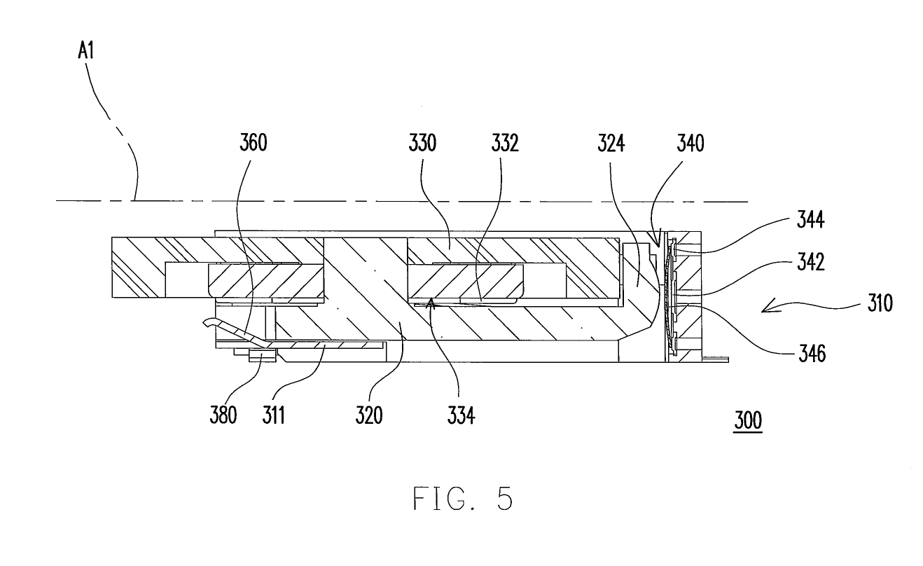

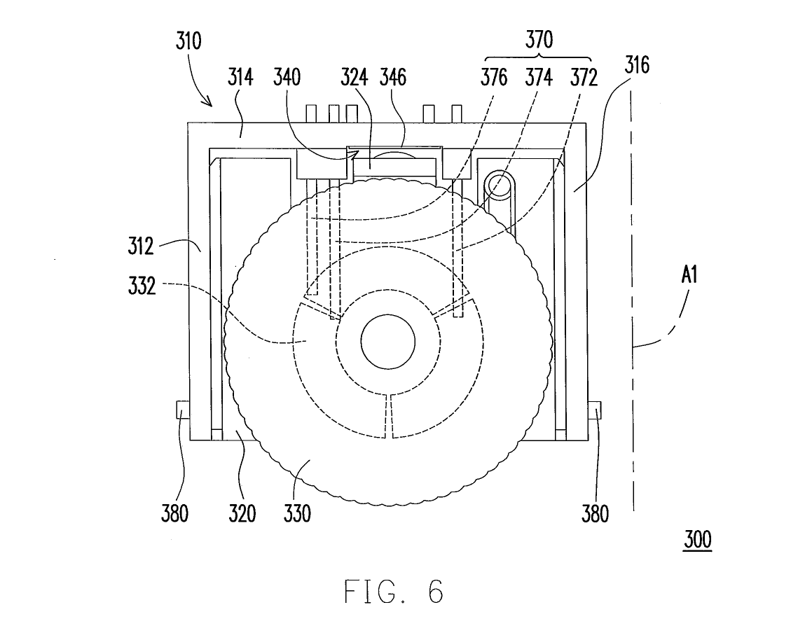

FIG. 5 is a schematic cross-sectional view along line I-I of the input device in FIG. 3. FIG. 6 is a schematic top view of the input device in FIG. 3. As shown in FIGS. 5 and 6, the switch 340 in the first embodiment includes a central electrode 342, a ring electrode 344 and a drum-shaped spring plate 346. The central electrode 342 is disposed on the frame 310 and the ring electrode 344 is disposed on the frame 310 and around the central electrode 342. The drum-shaped spring plate 346 is disposed near the central electrode 342. Furthermore, an edge of the drum-shaped spring plate 346 is electrically connected to the ring electrode 344, and the ring electrode 344 is in a normally electrified state.

More specifically, when the rotary wheel 330 is subjected to an external force acting along the slide axis A1 toward the interior of the frame 310, the rotary wheel 330 slides into the interior of the frame 310 through the sliding base 320. Furthermore, a press board 324 between the rotary wheel 330 and the switch 340 will apply a pressure to the drum-shaped spring plate 346 so that the drum-shaped spring plate 346 may produce an elastic deformation and form an electrical connection with the central electrode 342. Therefore, the switch 340 is actuated to transmit an electrical signal. When the aforementioned external force no longer applies to the rotary wheel 330, the drum-shaped spring plate 346 returns to its initial state due to elastic restoring force in itself and electrically disconnects from the central electrode 342. Furthermore, the elastic restoring force of the drum-shaped spring plate 346 pushes the press board 324 so that the sliding base 320 slides along the slide axis A1 towards the exterior of the frame 310. As shown in FIG. 5, the press board 324 in the first embodiment extends from the sliding base 320 to the space between the rotary wheel 330 and the switch 340. The function of the press board 324 is to apply a balanced pressure on the drum-shaped spring plate 346.

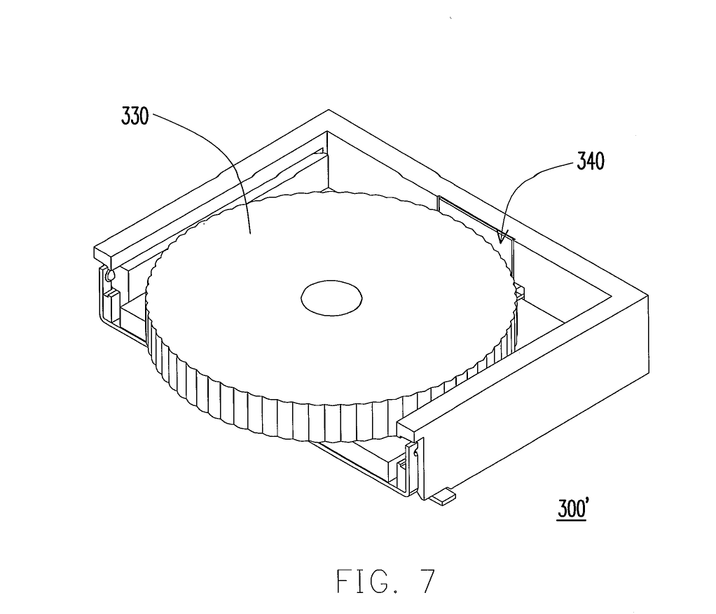

FIG. 7 is a schematic perspective view of another input device according to the first embodiment of the present invention. It should be noted that the main difference between the input device 300 and the input device 300′ is that the designer might remove the press board 324 (refer to FIG. 5) according to the design requirement (for example, to reduce the volume of the input device 300′ further) so that the rotary wheel 330 could apply a pressure directly to the switch 340 and actuate the switch 340.

As shown in FIGS. 3 and 4, in order to prevent the sliding base 320 from being pushed away from the frame 310 through the elastic restoring force of the drum-shaped spring plate 346, the input device 300 in the first embodiment further includes at least a limiting portion 350 disposed on the frame 310. In the first embodiment, two limiting portions 350 are used. The limiting portions 350 are disposed on the sidewall 312 and the sidewall 316 of the frame 310 respectively. The function of the limiting portions 350 is to form a limited space S together with the frame 310, that is, a containing space of the frame 310 in the first embodiment. Hence, the sliding base 320 is only allowed to slide inside the limited space S formed between the frame 310 and the limiting portions 350.

In the first embodiment, the frame 310 further includes a bottom plate 311. The bottom plate 311 may be fabricated from a conductive material such as metal. The bottom plate 311 is substantially parallel to the circuit board P. The bottom plate 311 may connect with the sidewalls 312 and 316 to reinforce and stabilize the relative position of the sidewalls 312 and 316 near their ends. The method of fixing the bottom plate 311 of the first embodiment includes bending the two sides of the bottom plate 311 and embedding the bent portions of the bottom plate 311 inside the sidewall 312 and the sidewall 316 respectively. However, the foregoing method of fixing the bottom plate 311 is only one example and should not be used to limit the scope of the present invention.

Furthermore, the metal conductive bottom plate 311 of the input device 300 further includes a grounding portion 360 and a plurality of bonding portions 380. The grounding portion 360 extends from the bottom plate 311 to the neighboring region of the rotary wheel 330 and the bonding portions 380 extend from the bottom plate 311 in a direction away from the rotary wheel 330. The bottom plate 311 may be bonded and fixed to the grounding circuit (not shown) of the circuit board P through the bonding portions 380. When the user operates the rotary wheel 330, static electricity picked up by the fingers of the user may be discharged through the grounding portion 360 such that other circuits (not shown) of the circuit board P are prevented from any damage due to the static electricity on the user's fingers.

Although the bottom plate 311 is incapable of discharging static charges to the grounding circuit of the circuit board P if the bottom plate 311 of the input device 300 is made from a non-metallic or insulating material, the bottom plate 311 still simplifies the mold design and facilitates the manufacturing of the frame 310. Moreover, the bottom plate 311 still serves the functions of maintaining the same relative position between the sidewall 312 and the sidewall 316 of the frame 310 and enhancing the mechanical strength of the frame 310.

Again, as shown in FIGS. 5 and 6, the rotary wheel 330 in the first embodiment may have a plurality of conducting portions 332 and these conducting portions 332 are disposed around a bottom surface 334 of the rotary wheel 330. In addition, the input device 300 of the first embodiment may further include an encoder 370 one end of which is disposed on the frame 310 and the other end of which is in contact with the conducting portions 332 of the rotary wheel 330. The encoder 370 includes a first conducting terminal 372, a second conducting terminal 374, a third conducting terminal 376 and a metal conducting disk (not shown in the figure) on the bottom surface 334 of the rotary wheel 330.

When the rotary wheel 330 is rotated, the encoder 370 provides the circuit on the circuit board P with rotating direction and related information of the rotary wheel 330. It should be noted that the encoder 370 with the first conducting terminal 372, the second conducting terminal 374 and the third conducting terminal 376 and the relative location between the encoder 370 and the conducting portions 332 are given only as an example. The designer may change the components, shape and location of the encoder 370 as well as the shape and location of the conducting portions 332 as long as the design will not affect the functions of the encoder 370 to transmit information regarding the rotating direction and rotating speed of the rotary wheel 330. Therefore, the first embodiment is used only as an example and not as a limitation to the present invention.

### Second Embodiment

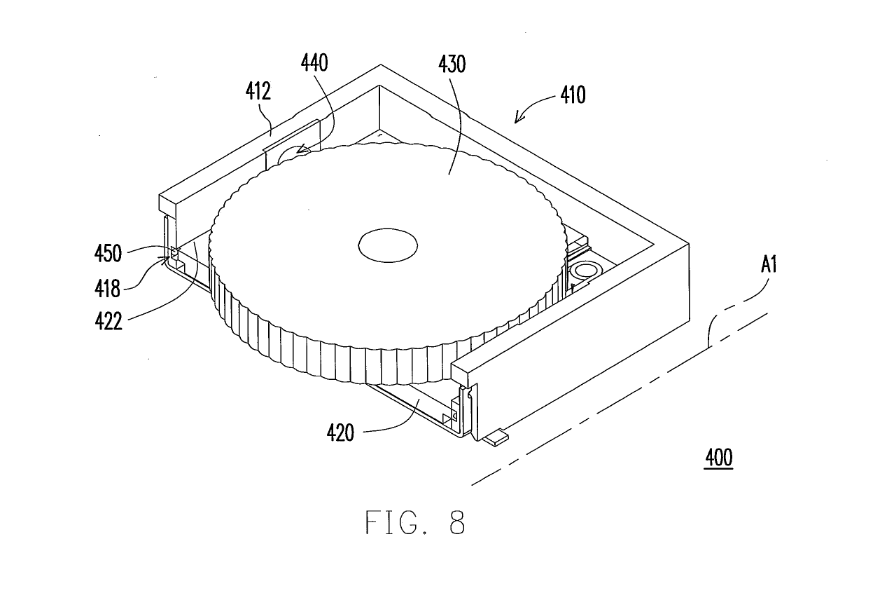

FIG. 8 is a schematic perspective view of an input device according to a second embodiment of the present invention. The main difference between the input device 400 in the second embodiment and the input device 300 in the first embodiment is that the switch 440 of the second input device 400 is disposed on the sidewall 412 on the sliding path of the rotary wheel 430 or the sliding base 420. When the rotary wheel 430 slides along the slide axis A1 toward the interior of the frame 410, the rotary wheel 430 slides toward the interior of the frame 410 through the sliding base 420 and the edge of the rotary wheel 430 closest to the sidewall 412 will apply a pressure to the switch 440 to actuate the switch 440.

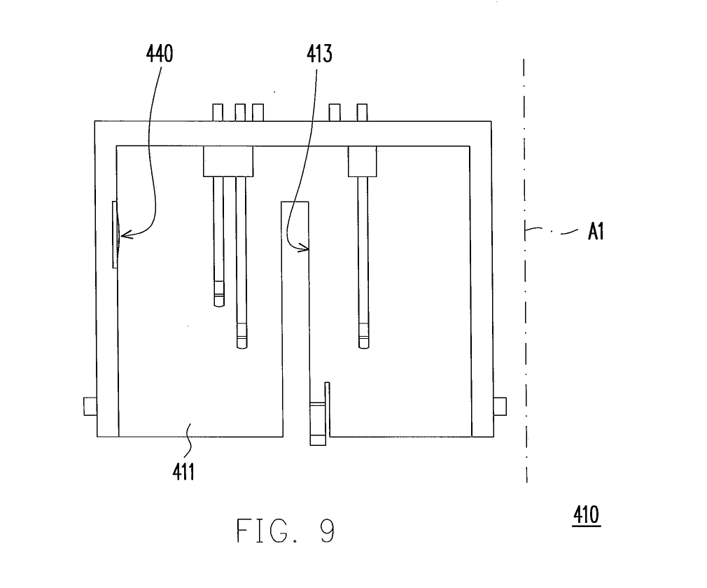

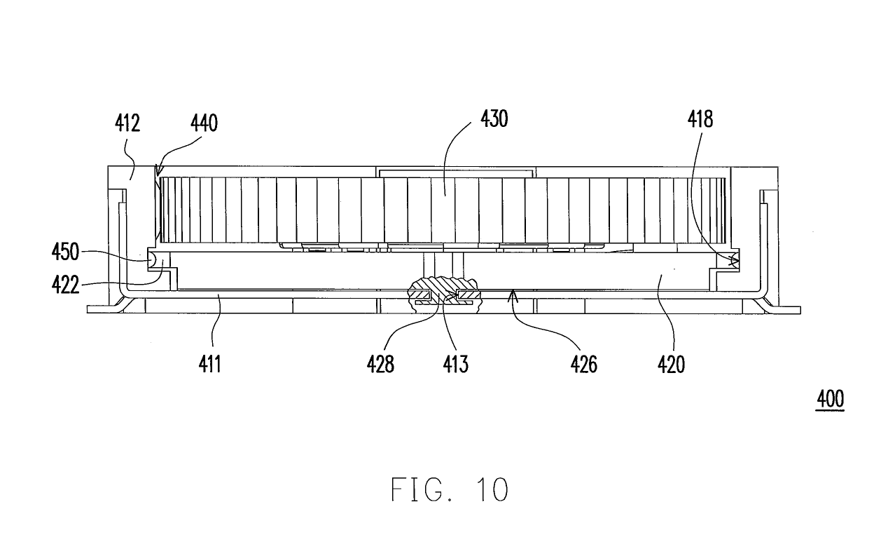

FIG. 9 is a schematic top view of the frame in FIG. 8. FIG. 10 is a schematic front view of the input device in FIG. 8. To facilitate the description, some local cross-sections are shown in FIG. 10. As shown in FIGS. 9 and 10, the input device 400 of the second embodiment differs from the input device 300 of the first embodiment. To stabilize the sliding connection of the sliding base 420 to the frame 410, the frame 410 in the second embodiment may have at least a third sliding connection portion 413 disposed on the bottom plate 411. The third sliding connection portion 413 is substantially parallel to the slide axis A1. Furthermore, the sliding base 420 may have at least a fourth sliding connection portion 428 disposed on a bottom surface 426 of the sliding base 420. The fourth sliding connection portion 428 is slidingly connected to the third sliding connection portion 413. In the second embodiment, the third sliding connection portion 413 may be a sliding rail and the fourth sliding connection portion 428 may be a sliding block.

It should be noted that the designer might design the third sliding connection portion 413 as a sliding block and the fourth sliding connection portion 428 as a sliding rail as long as the sliding connection between the sliding base 420 and the frame 410 is unaffected. However, the foregoing conditions are not shown in the drawings. In addition, in the second embodiment, the frame 410 may have two first sliding connection portions 418 and one third sliding connection portion 413, and the sliding base 420 has two second sliding connection portions 422 and one fourth sliding connection portion 428. However, as long as the sliding connection between the sliding base 420 and the frame 410 is unaffected, the designer may vary the number of sliding connection portion according to the actual requirement. For example, the frame 410 may have one first sliding connection portion 418 and one third sliding connection portion 413 and the sliding base 420 may have one second sliding connection portion 422 and one fourth sliding connection portion 428. Alternatively, the frame 410 may have at least one third sliding connection portion 413 and eliminate the first sliding connection portion 418 altogether, and the sliding base may have at least one fourth sliding connection portion 428 and eliminate the second sliding connection portion 422 altogether. Accordingly, the second embodiment is used only as an example and not as a limitation to the present invention.

Another difference between the input device 400 of the second embodiment and the input device 300 of the first embodiment is the locations of the limiting portions 450, the shapes and the locations of the first sliding connection portions 418 and the second sliding connection portions 422. However, since the functions of the limiting portions 450, the first sliding connection portions 418 and the second sliding connection portions 422 in the second embodiment are similar to the ones in the first embodiment, a detailed description is omitted.

### Third Embodiment

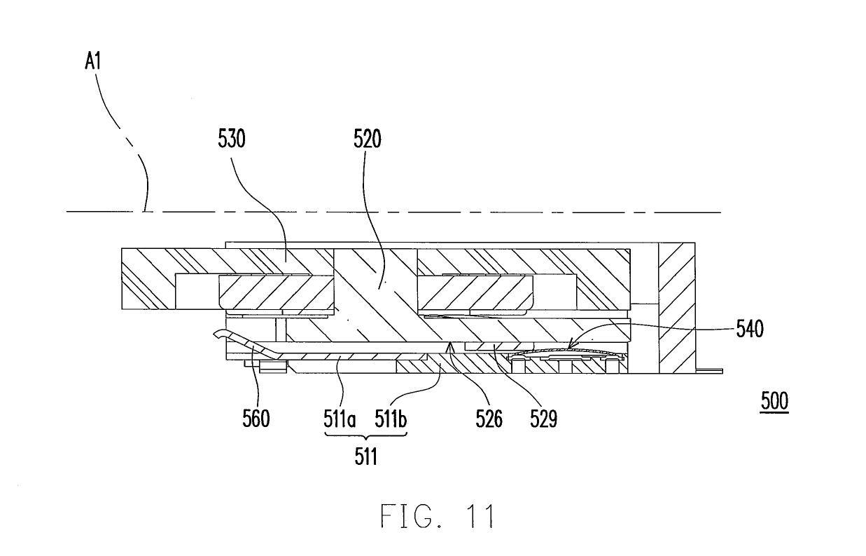

FIG. 11 is a schematic cross-sectional view of an input device according to a third embodiment of the present invention. The main difference between the input device 500 of the third embodiment and the input devices 300 and 400 in the foregoing embodiments is that the switch 540 of the input device 500 may be disposed on the bottom plate 511. Furthermore, the sliding base 520 has a bulge 529 disposed on its bottom surface 526. When the rotary wheel 530 is acted on by an external force along the slide axis A1 toward the interior of the frame 510, the rotary wheel 530 slides into the interior of the frame 510 through the sliding base 520 and the sliding motion of the sliding base 520 causes the bulge 529 to apply a pressure on the switch 540 to actuate the switch 540.

It should be noted that that bottom plate 511 have a conducting portion 511a and an insulating portion 511b in the present embodiment. The conducting portion 511a is electrically connected to the grounding portion 560. Furthermore, the conducting portion 511a is embedded within the insulating portion 511b and the switch 540 is disposed on the insulating portion 511b.

In summary, the input device of the present invention has at least the following merits.

1. Because the rotary wheel in the input device of the present invention rotates around a rotation axis substantially perpendicular to the circuit board and the sliding base substantially slides linearly along a slide axis parallel to the circuit board, the overall height profile of the rotary wheel, the sliding base and the circuit board is rather low. Thus, the input device of the present invention occupies a smaller volume.

2. Because the input device of the present invention may actuate the switch through the sliding motion of the sliding base, the L-shaped actuator in the conventional input device is not required. Therefore, the input device of the present invention may be easily assembled and more durable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An input device, disposed on a circuit board, the input device comprising:
a frame;
a sliding base, slidingly connected to the frame, wherein the sliding base substantially slides linearly along a slide axis, and the slide axis is substantially parallel to the circuit board;
a rotary wheel, revolvably affixed to the sliding base, wherein the rotary wheel rotates substantially around a rotation axis, and the rotation axis is substantially perpendicular to the circuit board; and
a switch, disposed on the frame, wherein the rotary wheel actuates the switch through the sliding motion of the sliding base.

2. The input device of claim 1, wherein the frame has at least a first sliding connection portion, and the sliding base has at least a second sliding connection portion such that the sliding base slides linearly into the interior of the frame through the relative sliding motion between the second sliding connection portion and the first sliding connection portion.

3. The input device of claim 2, wherein the frame comprises:
a first sidewall, substantially parallel to the slide axis and perpendicular to the circuit board; and
a second sidewall, disposed on the opposite side of the first sidewall.

4. The input device of claim 3, wherein the frame further comprises a third sidewall connecting with the first sidewall and the second sidewall, and the switch is disposed on the first sidewall, the second sidewall or the third sidewall and on a sliding path of the sliding base.

5. The input device of claim 3, wherein the frame comprises two first sliding connection portions disposed on the first sidewall and the second sidewall respectively, and the sliding base has two second sliding connection portions disposed on two opposite sides of the sliding base, and the second sliding connection portions are slidingly connected to the first sliding connection portions respectively.

6. The input device of claim 2, wherein the frame comprises a bottom plate disposed substantially in parallel to the circuit board.

7. The input device of claim 6, wherein the switch is disposed on the bottom plate and a material of the bottom plate comprise insulating material.

8. The input device of claim 7, wherein the sliding base has a bulge disposed on a bottom surface of the sliding base, and the bulge is suitable for actuating the switching through the sliding motion of the sliding base.

9. The input device of claim 6, wherein the first sliding connection portion is disposed on the bottom plate and the second sliding connection portion is disposed on a bottom surface of the sliding base, and the second sliding connection portion is slidingly connected to the first sliding connection portion.

10. The input device of claim 6, further comprising a grounding portion that extends from the bottom plate to a neighboring region of the rotary wheel and a material of the bottom plate comprise conductive material.

11. The input device of claim 1, wherein the switch comprises:
a central electrode, disposed on the frame;
a ring electrode, disposed on the frame and around the central electrode; and
a drum-shaped spring plate, wherein an edge of the drum-shaped spring plate is electrically connected to the ring electrode, and the drum-shaped spring plate contacts the central electrode when the drum-shaped spring plate is deformed.

12. The input device of claim 1, further comprising an encoder, wherein an end of the encoder is disposed on the frame and the other end of the encoder contacts the rotary wheel.

13. The input device of claim 1, further comprising at least a limiting portion disposed on the frame, wherein the sliding base slides within a limited space between the frame and the limiting portion.

14. The input device of claim 1, wherein the sliding base further comprises a press board located between the rotary wheel and the switch such that the press board actuates the switch through the sliding motion of the sliding base.
